(19) United States
(12) Patent Application Publication
(10) Pub. No.: US 2015/0049500 A1
(43) Pub. Date: Feb. 19, 2015

(54) VEHICLE INTERIOR AND PORTABLE ACCESSORY LIGHT ASSEMBLY

(71) Applicant: Ford Global Technologies, LLC, Dearborn, MI (US)

(72) Inventors: Artur Sakarian, Birmingham, MI (US); Kristin Ann Hellman, Walled Lake, MI (US); Timothy Son Hing, Plymouth, MI (US); Ryan Welch, Ottawa Lake, MI (US); Annette Lynn Huebner, White Lake, MI (US)

(73) Assignee: Ford Global Technologies, LLC, Dearborn, MI (US)

(21) Appl. No.: 13/966,438

(22) Filed: Aug. 14, 2013

(51) Int. Cl. F21L 4/08; F21V 21/092

(52) U.S. Cl. CPC F21L 4/08; F21V 21/0925
USPC 362/486

(57) ABSTRACT

A vehicle interior light assembly is provided. The assembly includes a housing having a light support and a cover door. The assembly also includes a portable lighting device including a light source and a plurality of reconfigurable legs to support the lighting device. The lighting device installs onto the light support within the housing to serve as a vehicle interior light and is removable from the housing for use as a portable accessory light.

### FIELD OF THE INVENTION

The present invention generally relates to vehicle lighting, and more particularly relates to a portable lighting device configured for use as a vehicle interior light.

### BACKGROUND OF THE INVENTION

Automotive vehicles are typically equipped with various lighting assemblies for providing interior lighting. A vehicle dome light assembly is often installed in the headliner or the overhead bin of a vehicle to provide dome lighting for passengers within the vehicle. A dome light assembly typically includes a light source and a cover lens, and employs a switch for activating the light on and off. The light source is typically fixed to the dome light assembly which is fixedly installed on the vehicle and not intended to be readily removed therefrom. It is desirable to provide for a lighting device that may easily provide accessory lighting for various applications.

### SUMMARY OF THE INVENTION

According to one aspect of the present invention, a vehicle light assembly is provided. The vehicle light assembly includes a housing having a light support. The vehicle light assembly also includes a portable lighting device including a light source and a plurality of reconfigurable support legs. The lighting device installs onto the light support within the housing to serve as a vehicle interior light and is removable from the light support for use as a portable accessory light.

According to another aspect of the present invention, a vehicle light assembly is provided. The vehicle light assembly includes a housing including a light support. The vehicle light assembly also includes a portable lighting device including a light source and a reconfigurable support that is configurable to support the lighting device. The lighting device installs onto the light support within the housing to serve as a fixed vehicle interior light and is removable from the light support for use as a portable accessory light.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of the passenger compartment of a vehicle illustrating an interior dome light assembly and various uses of a portable accessory lighting device, according to one embodiment;

FIG. 1A is a perspective view of the portable accessory lighting device shown used outside the vehicle, according to one example;

FIG. 2 is a perspective view of the vehicle interior light assembly illustrating the portable accessory lighting device for use as the light source;

FIG. 3 is a cross-sectional view taken through line III-III of FIG. 2 further illustrating the light assembly;

FIG. 4 is a perspective view of the light assembly with the bottom cover in the open position and the portable accessory lighting device removed;

FIG. 5 is a side view of the light assembly with the cover in the open position with the portable accessory lighting device removed;

FIG. 6 is a front view of the light assembly with the cover removed from the housing and the portable accessory lighting device installed therein;

FIG. 7 is a cross-sectional view taken through line VII-VII of FIG. 1A showing one of the reconfigurable support legs; and

FIG. 8 is an exploded view of the portable accessory lighting device.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

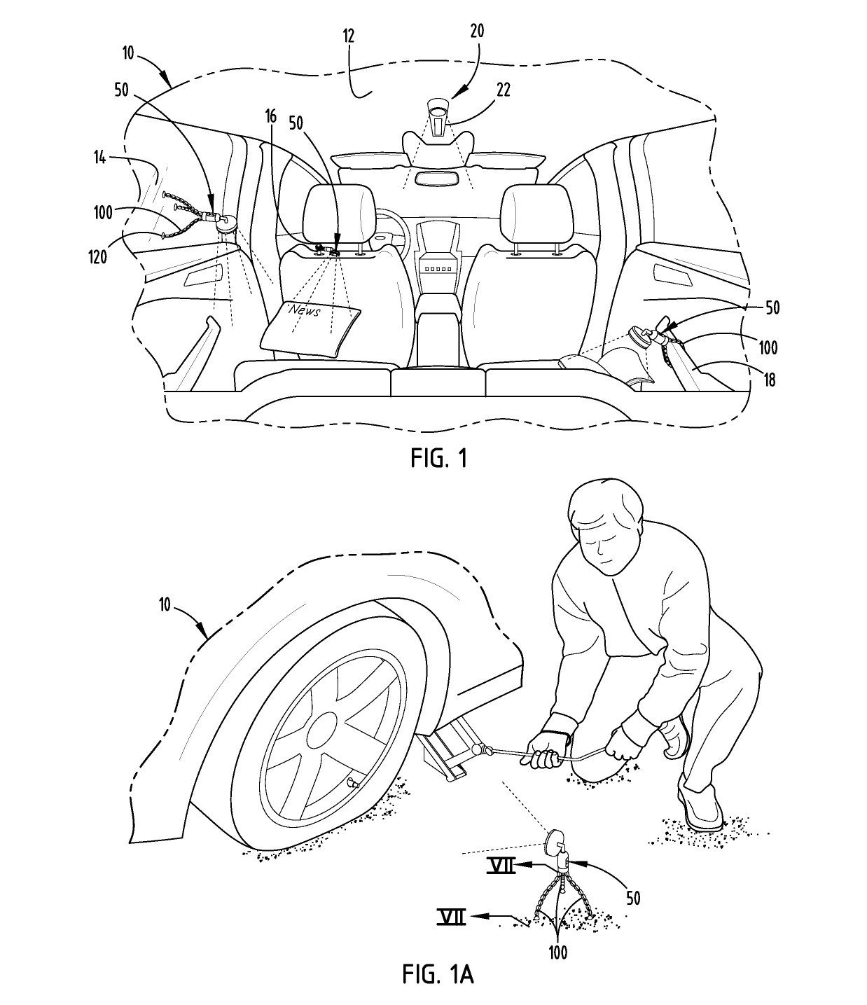

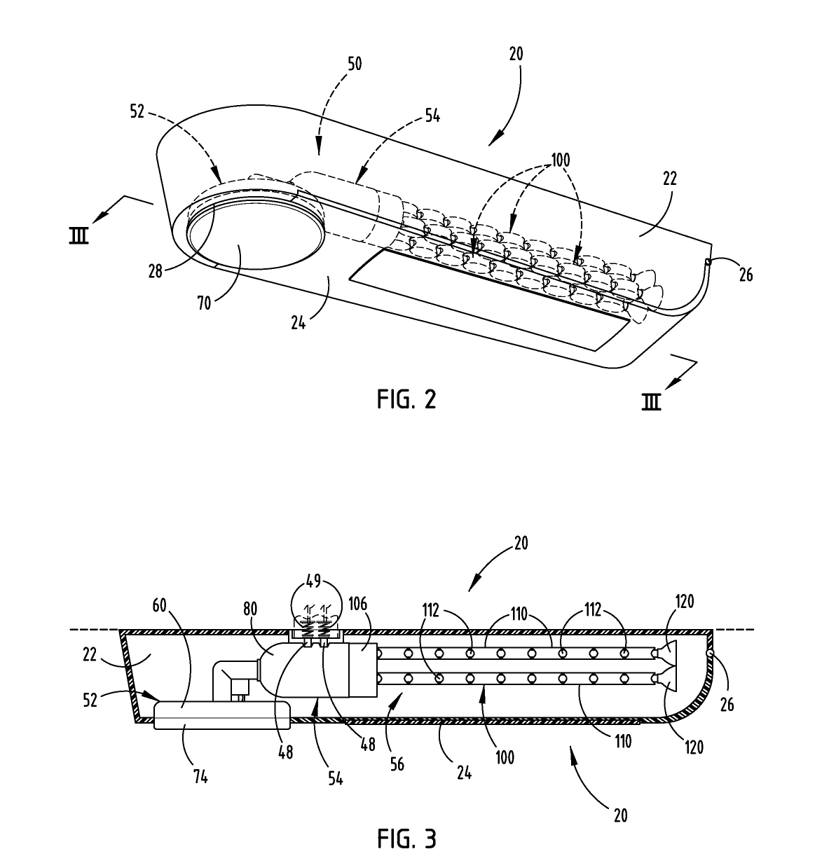

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, the passenger compartment of an automotive vehicle 10 is generally illustrated having a vehicle interior light assembly 20 shown installed in the overhead headliner 12 of vehicle 10. The interior light assembly 20 includes a housing 22 configured to receive and house a portable accessory lighting device 50 for use as overhead dome lighting in the vehicle 10. The portable accessory lighting device 50 installs onto a light support within the housing 22 such that the accessory lighting device 50 serves as a vehicle interior light, such as the center mounted, overhead dome light, and is readily removable by a user from the housing 22 for use as a portable accessory light. When installed in the housing 22 as a dome light, the portable accessory lighting device 50 provides vehicle interior lighting when activated in response to a dome light signal such as a user activated switch. The vehicle interior light assembly 20 may otherwise be configured to provide other vehicle interior lighting, such as map and reading lights for map and reading purposes.

The portable accessory lighting device 50 is shown in FIG. 1 removed from the housing 22 and in various use applications supported by reconfigurable legs 100 including installation via suction cups 120 onto the interior surface of a side glass window 14, installation on a seat headrest support bar 16, and installation on a rear door handle 18. The accessory lighting device 50 is portable in that a user may readily handle and transport that lighting device 50 and position it on the ground or install it on other objects for various lighting applications. The accessory lighting device has a reconfigurable support having a plurality of reconfigurable support legs 100 that articulate relative to each other and are reshapeable by a user applying force to each leg 100 to realize a desired configuration. Each support leg 100 has a suction cup 120 provided on the terminal end thereof for allowing various placements of the lighting device 50 on a smooth surface such as a window. In addition to use applications onboard the vehicle 10, the portable accessory lighting device 50 may be used outside of the vehicle 10 as shown in FIG. 1A in which lighting device 50 illuminates a wheel and tire assembly during a user's changing of the tire, according to one example. It should be appreciated that the accessory lighting device 50 may be used in various other applications and locations as a portable lighting device.

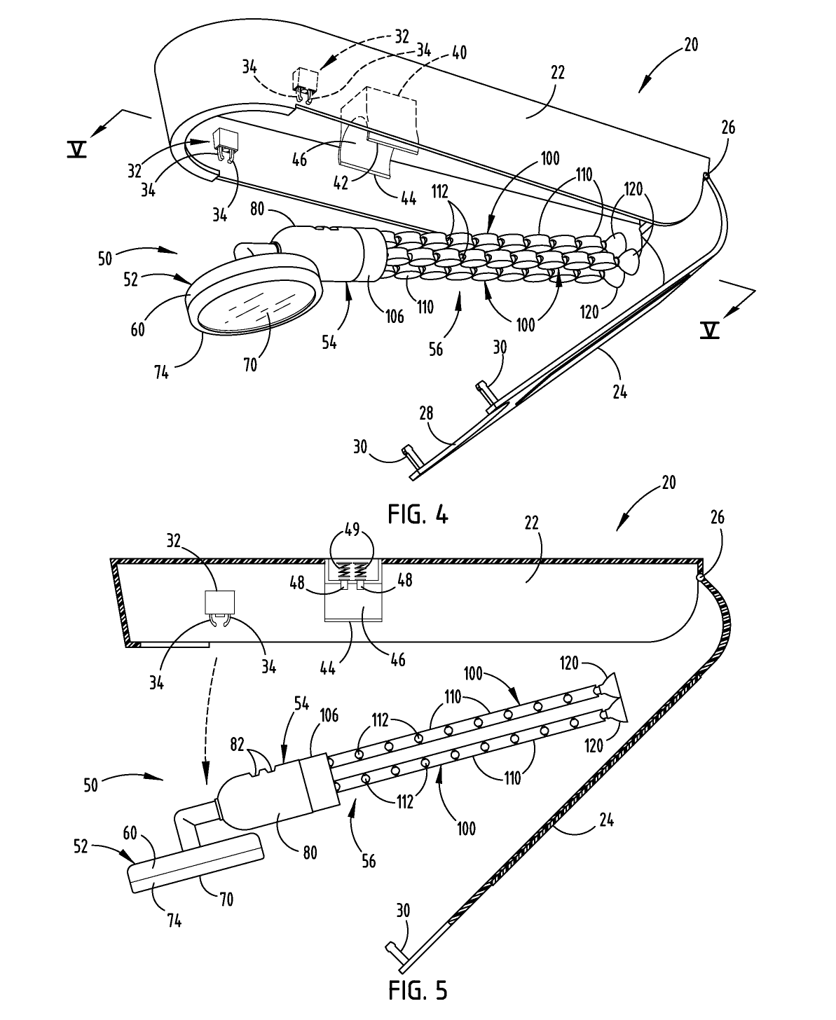

The vehicle light assembly 20 and its installation and removal of the portable accessory lighting device 50 relative to housing 22 are illustrated further in FIGS. 2-6. The light assembly 20 includes a housing 22 having side walls that define a storage and recharging compartment and a cover door 24 hingedly connected at the bottom side of housing 22 via hinge 26. The cover door 24 pivots relative to hinge 26 between the open position shown in FIGS. 4 and 5, and the closed position shown in FIGS. 2 and 3. The cover door 24 has a U-shape terminal end 28 that abuts a circular shaped, lighting head portion 52 of the accessory lighting device 50 to allow light to penetrate or exit therefrom.

The cover door 24 may include a push-push click latch to latch and unlatch the cover door 24 with successive forced actuations. In one embodiment, the cover door 24 includes a pair of upper extending and spaced connecting pins 30 that are configured with enlarged heads to engage resilient prongs 34 of a female receiving member 32 to hold the cover door 24 in the closed position with sufficient resistance during normal vehicle driving conditions. A user may apply upward force onto the cover door 24 by pressing on the bottom surface of door 24 to force connecting pins 30 into frictional engagement with prongs 34 or to disengage connecting pins 30 from engagement with prongs 34 to open the door 24.

The housing 22 may be installed onto the headliner 12 of the vehicle, an overhead console, or other interior ceiling member such that the light assembly 20 is generally located near the vehicle interior ceiling to provide overhead light illumination downward within the passenger compartment of the vehicle 10, according to one embodiment. In the embodiment shown, the light assembly 20 is centrally located overhead in the vehicle passenger compartment to serve as a vehicle dome light. The housing 22 includes a light support 40 that is adapted to retain and hold the portable accessory lighting device 50 in position within housing 22 for use as the overhead dome lamp. Light support 40 has a shape and size similar to the shape and size of a base portion 54 of the lighting device 50 to receive and retain the lighting device 50 in a desired position and orientation. Specifically, light support 40 has a semicircular receiving portion 46 having opposing end prongs 42 and 44 that receive the cylindrical base portion 54 of the accessory lighting device 50 to hold the accessory lighting device 50 in position within housing 22. The opposing end prongs 42 and 44 may be resilient so as to flex when the base portion 54 is forcibly inserted into engagement within receiving portion 46 or removed therefrom.

The light support 40 further includes a pair of electrical contacts 48 in the form of contact pins that are positioned to engage and make electrical contact with recessed charging contacts 82 provided on the base portion 54 of the accessory lighting device 50. The electrical contacts 48 may include spring biased contacts that are spring biased via springs 49 to ensure physical contact between contacts 48 and the recessed charging contacts 82 despite variations in placement of the accessory lighting device 50 relative to the light support 40 and housing 22. The recessed charging contacts 82, in turn, are electrically coupled to a rechargeable battery within the accessory lighting device 50. As such, the rechargeable battery is recharged with electrical energy from the vehicle electrical source (e.g., car battery) when the accessory lighting device 50 is aligned and installed on the light support 40 within housing 22 and recessed charging contacts 82 are in electrical contact with contacts 48. While the electrical charging configuration shown and described herein employs electrical contacts that physically contact one another, according to one embodiment, it should be appreciated that other charging circuitry may be employed, such as wireless inductive charging, according to other embodiments. In addition, it should be appreciated that a dome light signal may be transmit from the vehicle to the lighting device either wirelessly or via a signal contact provided in the housing 22 to activate the light source to provide dome lighting.

The portable accessory lighting device 50 includes three articulating and reconfigurable support legs 100 which serve as the supporting portion 56 of lighting device 50 to serve as a stand, a twist or wrap support or other supporting structure. One of the reconfigurable support legs 100 is illustrated in FIG. 7 having a plurality of interconnected segments 110 serially connected via links 112 in a manner to allow flexure and reconfiguration of the leg 100 about multiple axes. Segments 110 may be made of rubber and may have a shape of a disc, according to one embodiment, having a recessed opening or socket 116 at opposite ends for receiving an enlarged spherical head 114 of link 112 to form a ball and socket connection between adjoining link 112 and segment 110. Each link 112 has a central shaft with enlarged spherical heads 114 at opposite ends and may be made of a polymeric material or plastic. The enlarged spherical head 114 is trapped within socket 116 and is movable relative to segments 110 when sufficient force is applied by a user to reconfigure the shape of the leg 100. As such, adjacent links 112 are able to rotate and pivot in multiple axes relative to the ball and socket connection. Each leg 100 may be articulated and twisted by a user in various directions and be rotated to form a user reconfigured shape that is desired to support the accessory lighting device 50 in various orientations. The reconfigurable legs 100 may therefore provide a freestanding support for lighting device 50 or may engage and wrap around members and retain the accessory lighting device 50 in a desired orientation and position.

In one embodiment, the rubber segments 110 are flexible and may bend independent of the pivoting ball and socket connection formed with the links 112. The links 112 may be rigid, according to one embodiment. According to other embodiments, the links 112 may be made of a flexible material that may flex independent of the ball and socket connection and the segments 110 may be made of a rigid material. The ball and socket connection between segments 110 and links 112 allows for rotation of segments 110 relative to links 112 about the longitudinal axis and rotation in other axes. Each segment 110 and interconnecting link 112 allows for relative motion therebetween to allow for various configurations of the reconfigurable legs 100. In addition, the uppermost enlarged spherical head of link 112 serves as a tripod pivot connector 102 that is adapted to connect to a tripod stand to support the leg 100 relative to the other legs 100 and may include various shapes and sizes for allowing articulating motion of each leg 100.

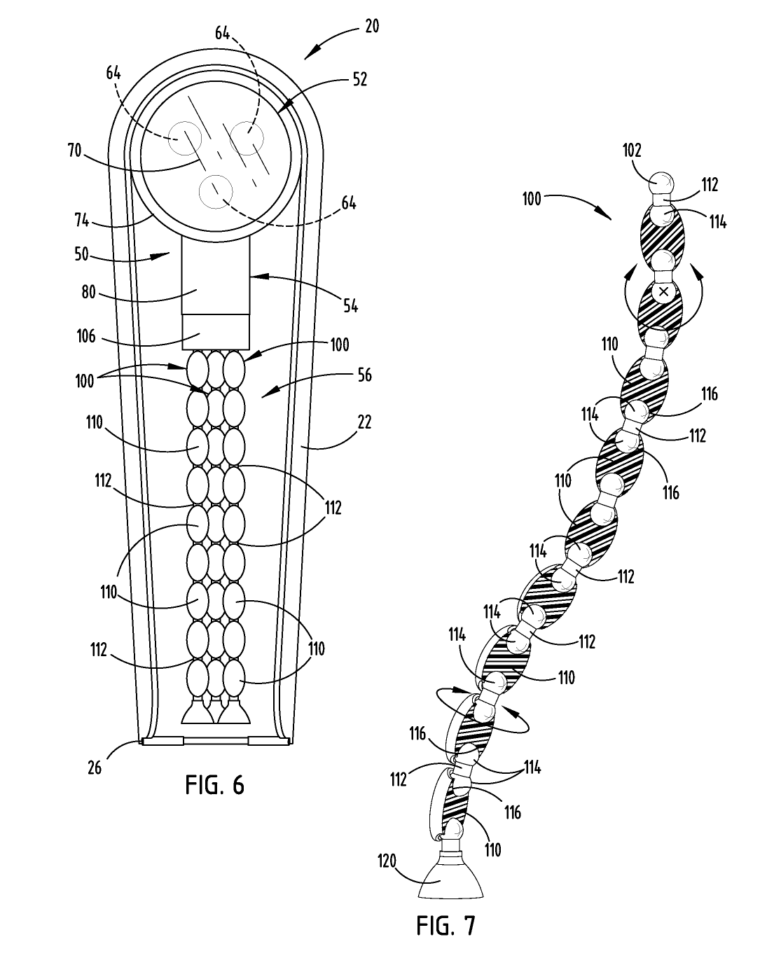

The articulating legs 100 are easily reconfigured to various configurations. The reconfigurable legs 100 may be aligned substantially straight and parallel to one another in an unexpanded arrangement as shown in FIG. 6 for easy insertion and installation in the housing 22. With the reconfigurable legs 100 in the unexpanded configuration, the three reconfigurable legs 100 may also serve as a handle for removing the lighting device 50 from housing 22 and transporting the lighting device 50 for portable applications. A user may pivot the reconfigurable legs 100 relative to one another to form a tripod and may shape each individual leg to achieve a desired orientation of the lighting device 50. In addition, each leg 100 may be bent to wrap around an object and the suction cups 120 may be suctioned to a flat surface, such as a window. It should be appreciated that various other applications of the portable accessory lighting device 50 may be realized.

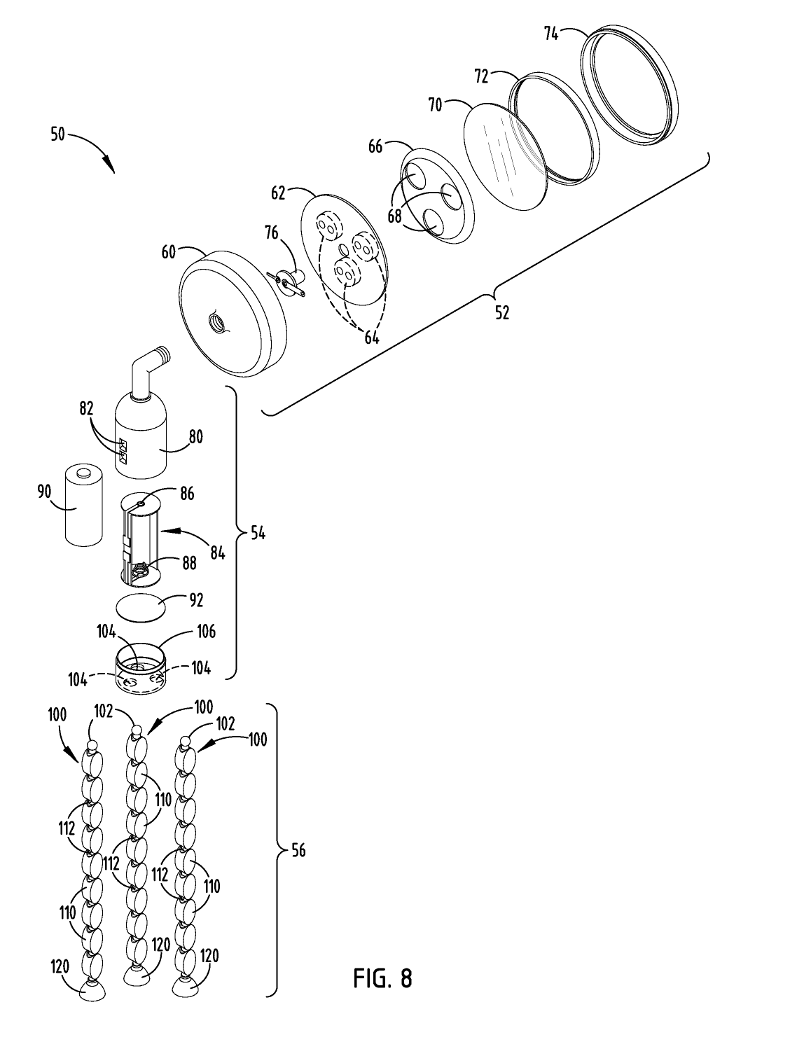

Referring to FIG. 8, the accessory lighting device 50 is further illustrated. Head portion 52 is shown having a rear support bezel 60 for receiving a circuit board 62 having three lighting sources 64 shown as three light emitting diodes (LEDs) mounted thereon. A cover plate 66 having three windows 68 is disposed in front of the circuit board 62 such that the openings 64 are aligned with the light sources 64 to allow output light to penetrate therethrough. A lens 70 is disposed in front of cover plate 66 and is held in place via ring 72 and collar 74. In addition, a push actuated switch 76 is shown disposed on circuit board 62 and has a portion that extends through circuit board 62 and contacts cover plate 66. Depression of the lens 70 causes cover plate 66 to forcibly activate the switch 76 to turn the lighting device 50 on and off, with each repeated depression of the lens 70 causing switch 76 to switch on and off states. A user may turn the accessory lighting device 50 on by pushing on the lens 70 and off by repeatedly depressing the lens 70.

The head portion 52 of lighting device 50 is connected to base portion 54 which has a housing 80 adapted to be fastened to support bezel 60. Housing 80 has a compartment for receiving a battery receptacle 84 with positive and negative contacts 86 and 88 which are adapted to receive a rechargeable battery 90. Electrical circuitry is included to supply electrical power from the battery 90 to the light sources 64 when switch 76 is activated. The battery compartment 84 has electrical circuitry connected to electrical contacts 82 which allows for the rechargeable battery 90 to be charged when electrical contact is made with the spring biased contacts 48 within the housing 22. The rechargeable battery 90 may supply DC voltage and charging circuitry may be included in the vehicle 10, the light assembly housing 22 or the lighting device 50.

The supporting portion of the accessory lighting device 50 is shown having three flexible articulating and reconfigurable legs 100. Each of the three reconfigurable legs 100 has a tripod pivot connector 102 at the top end thereof configured to be received within any opening or socket 104 in tripod support member 106. As such, the ball and socket connection between each tripod pivot connector 102 and socket 104 allows each of the three supporting legs 100 to articulate by pivoting and rotating in various directions. A plate 92 is disposed over member 106. Legs 100 further have suction cups 120 formed on the bottom ends thereof to allow for suctioned coupling to a smooth surface such as a window. It should be appreciated that each of the legs 100 may be self-supported and yet is reconfigurable to be adjusted into various orientations to position the accessory light device 50 as desired by a user.

Accordingly, the vehicle light assembly and accessory light device disclosed herein advantageously provides for a vehicle interior lighting, and further provides for an accessory light that is portable for both uses on and off the vehicle. As such, the vehicle light assembly and accessory lighting device advantageously provide multiple functions for improved vehicle lighting needs.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle light assembly comprising:
a housing comprising a light support located on a vehicle; and
a portable lighting device comprising a light source and a plurality of reconfigurable support legs, wherein the lighting device installs onto the light support within the housing to serve as a vehicle interior light and is removable from the light support for use as a portable accessory light.

2. The assembly of claim 1, wherein the lighting device comprises a rechargeable battery and charging contacts, wherein the charging contacts engage contacts in the housing to charge the rechargeable battery when the lighting device is installed on the light support in the housing.

3. The assembly of claim 1, wherein the plurality of reconfigurable legs comprise first, second and third legs that form a tripod, wherein each of said first, second and third legs pivots about one end nearest the light source.

4. The assembly of claim 1, wherein the light device comprises a lens covering the light source and a switch that is depressible to turn the light source on and off.

5. The assembly of claim 1, wherein the housing is located in an overhead region of a compartment of the vehicle to illuminate the compartment when used as the vehicle interior light.

6. The assembly of claim 5, wherein the vehicle interior light is a dome light.

7. The assembly of claim 1 further comprising a suction cup attached to one end of each of the plurality of reconfigurable legs to allow connection of the legs to a surface.

8. The assembly of claim 1, wherein each of the plurality of reconfigurable legs bends to allow the one or more of the legs to wrap around an object to hold the light device in a desired position.

9. The assembly of claim 1, wherein the light source comprises at least one light emitting diode.

10. The assembly of claim 1, wherein each of the reconfigurable legs comprises a plurality of rubber segments interconnected with pivoting rods.

11. The assembly of claim 1, wherein the housing further comprises a cover door that pivots relative to a base to allow insertion of the lighting device into the housing and removal of the lighting device from the housing.

12. A vehicle light assembly comprising:
a housing comprising a light support in a vehicle; and
a portable lighting device comprising a light source and a reconfigurable support that is configured to support the lighting device, wherein the lighting device installs onto the light support within the housing to serve as a fixed vehicle interior light and is removable from the light support for use as a portable accessory light.

13. The assembly of claim 12, wherein the light device comprises a rechargeable battery and first charging contacts, wherein the first charging contacts engage second charging contacts in the housing to charge the rechargeable battery when the lighting device is installed on the light support in the housing.

14. The assembly of claim 12, wherein the reconfigurable support comprises a plurality of legs comprise first, second and third reconfigurable legs that form a tripod, wherein each of said first, second and third legs pivots about one end.

15. The assembly of claim 14 further comprising a suction cup attached to one end of each of the plurality of reconfigurable legs to allow connection to a surface.

16. The assembly of claim 14, wherein each of the first, second and third reconfigurable legs comprises a plurality of rubber segments interconnected with pivoting rods.

17. The assembly of claim 12, wherein the light device comprises a lens covering the light source and a switch that is depressible to turn the light source on and off.

18. The assembly of claim 12, wherein the light source comprises at least one light emitting diode.

19. The assembly of claim 12, wherein the housing is located in an overhead region of a compartment of the vehicle to illuminate the compartment when used as the vehicle interior light.

20. The assembly of claim 19, wherein the vehicle interior light is a dome light.
